(19) United States
(12) Patent Application Publication
(10) Pub. No.: US 2024/0171885 A1
(43) Pub. Date: May 23, 2024

(54) SENSOR CONFIGURATION AND DATA SUPPLEMENTATION

(71) Applicant: International Business Machines Corporation, Armonk, NY (US)

(72) Inventors: Aaron K. Baughman, Cary, NC (US); Micah Forster, Round Rock, TX (US); Jeremy R. Fox, Georgetown, TX (US); Sarbajit K. Rakshit, Kolkata (IN)

(73) Assignee: International Business Machines Corporation, Armonk, NY (US)

(21) Appl. No.: 17/990,172

(22) Filed: Nov. 18, 2022

(51) Int. Cl. H04Q 9/02

(52) U.S. Cl. CPC H04Q 9/02

(57) ABSTRACT

By analyzing first configuration data of a set of sensors, a first configuration of the set of sensors is measured. A set of permutations of the first configuration is generated. For each permutation in the set of permutations, a corresponding set of virtual sensor data is generated. Using an analysis on each set of virtual sensor data and a set of real sensor data obtained using the first configuration, a corresponding analysis result is caused to be determined. Using the quality measure, a configuration producing a highest quality analysis result is determined. A contextual situation and the configuration are stored as a sensor configuration rule. By analyzing second configuration data of the set of sensors, a second configuration of the set of sensors is measured. The second configuration is adjusted according to the configuration specified in the sensor configuration rule.

### BACKGROUND

The present invention relates generally to a method, system, and computer program product for sensor management. More particularly, the present invention relates to a method, system, and computer program product for sensor configuration and data supplementation.

The Internet of Things (IoT) describes devices that include a processor, software, and an ability to exchange data with other devices or systems over a communications network such as the Internet. IoT devices often include one or more sensors, which collect data of an object or environment around an IoT device. Some non-limiting examples of sensors implemented in IoT devices measure temperature, humidity, pressure, voltage, electrical current, water flow, biomedical parameters such as heart rate and blood sugar, distance, speed, acceleration, changes in direction, speed, and acceleration, air quality, and amounts of a particular gas. Microphones and still or video cameras are also often implemented in IoT devices, to collect sound and image data. IoT devices are often implemented in groups. Multiple instances of the same sensor are often used to monitor different portions of a location, and a group of different sensors is often used to monitor different aspects of a location. For example, multiple cameras or air quality sensors might be used to monitor different rooms or floors of a building, and temperature, humidity, wind direction and speed, and cloud height sensors are typically used to monitor weather conditions at an airport. IoT sensors are typically configured to produce periodic observations at a sampling rate, such as once per second, minute, or hour. Each observation is tagged with a timestamp denoting a time the observation was made, to aid in analyzing observations and correlating observations from multiple sensors.

IoT sensors' outputs are often used as input to a downstream analysis. Some analyses are comparatively simple—e.g., activating an alarm when a carbon monoxide level is measured at above an alarm threshold. Other analyses are more complex—e.g., using a machine learning model to predict an approaching thunderstorm, using temperature, air pressure, wind, and lightning sensor data as well as weather radar images.

### SUMMARY

The illustrative embodiments provide a method, system, and computer program product. An embodiment includes a method that measures, by analyzing first configuration data of a set of sensors, a first configuration of the set of sensors. An embodiment generates a set of permutations of the first configuration, a permutation in the set of permutations comprising an adjusted configuration of the set of sensors. An embodiment generates, for each permutation in the set of permutations, a corresponding set of virtual sensor data. An embodiment causes determining, using an analysis on each set of virtual sensor data and a set of real sensor data obtained using the first configuration, a corresponding analysis result, a contextual situation specifying the analysis and a quality measure corresponding to the analysis. An embodiment determines, using the quality measure, a configuration producing a highest quality analysis result. An embodiment stores, as a sensor configuration rule, the contextual situation and the configuration. An embodiment measures, by analyzing second configuration data of the set of sensors, a second configuration of the set of sensors. An embodiment adjusting, according to the configuration specified in the sensor configuration rule, the second configuration, the adjusting resulting in a third configuration of the set of sensors.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for sensor configuration and data supplementation in accordance with an illustrative embodiment;

FIG. 3 depicts an example of sensor configuration and data supplementation in accordance with an illustrative embodiment;

FIG. 4 depicts a continued example of sensor configuration and data supplementation in accordance with an illustrative embodiment;

FIG. 5 depicts a continued example of sensor configuration and data supplementation in accordance with an illustrative embodiment;

FIG. 6 depicts a flowchart of an example process for sensor configuration and data supplementation in accordance with an illustrative embodiment;

FIG. 7 depicts a flowchart of an example process for sensor configuration and data supplementation in accordance with an illustrative embodiment.

### DETAILED DESCRIPTION

The illustrative embodiments recognize that the result quality of a downstream analysis is often related to the quality of the input data to the analysis, particularly when sensor data is part of the input data. For example, input sensor data might be too sparse in time or location to capture an event occurring in between measurements or measurement locations, or too noisy for effective signal isolation. As another example, the input data might be one type or format of sensor data, while the downstream analysis might be expecting a different type or format. Thus, the illustrative embodiments recognize that there is a need to configure a sensor or set of sensors according to an analysis to be performed on the data the sensor(s) collect.

The illustrative embodiments also recognize that sensor data quality can change over time. For example, a sensor might be moved, damaged, prevented from collecting data, have its data collection ability degraded or interfered with. Thus, the illustrative embodiments recognize that there is also a need to monitor a sensor or set of sensors, once configured according to an analysis, and adjust the configuration if necessary to maintain analysis quality.

The illustrative embodiments also recognize that a sensor or set of sensors cannot always be configured to result in a desired analysis quality. For example, a desired sensor location might be inaccessible, a replacement might be unavailable for a failed sensor, or a sensor capable of collecting data at a desired sample rate might not be available at a desired cost or at all. Thus, the illustrative embodiments recognize that there is also a need to generate virtual or simulated sensor data to supplement measured, real, sensor data, thus maintaining or improving analysis quality.

The illustrative embodiments recognize that the presently available tools or solutions do not address these needs or provide adequate solutions for these needs. The illustrative embodiments used to describe the invention generally address and solve the above-described problems and other problems related to sensor configuration and data supplementation.

An embodiment can be implemented as a software application. The application implementing an embodiment can be configured as a modification of an existing sensor management system, as a separate application that operates in conjunction with an existing sensor management system, a standalone application, or some combination thereof.

Particularly, some illustrative embodiments provide a method that determines a sensor configuration rule from first configuration data of a set of sensors and a contextual situation, measures, by analyzing second configuration data of the set of sensors, a second configuration of the set of sensors, and adjusts, according to the configuration specified in the sensor configuration rule, the second configuration, the adjustment resulting in a third configuration of the set of sensors.

An embodiment receives configuration data of a set of sensors. The set of sensors includes at least one sensor. Some non-limiting examples of sensor configuration data are the type of data the sensor measures, the data format, sample rate, sensor location, relative position from another sensor, and the like. An embodiment measures a configuration of the set of sensors by analyzing the sensor configuration data. For example, one measured sensor configuration might be that the set of sensors includes two wind sensors, reporting data in a particular data format and using a sample rate of one sample per minute, located at geographic locations that are opposite ends of an airport runway. Another example measured sensor configuration might be that the set of sensors includes a thermometer, reporting data in a particular data format and using a sample rate of one sample every five minutes, located on the only floor of a house at a particular address. A third example measured sensor configuration might be that the set of sensors includes five combination smoke, carbon monoxide, and radon sensors, each reporting data in a particular data format and using a sample rate of one sample per minute, located in each bedroom, the kitchen, and the basement of a house at a particular address, as well as one thermometer located in a hallway and window-open sensors on every ground-floor window of the house.

An embodiment generates a set of permutations of the configuration of the set of sensors. To generate a configuration permutation, an embodiment alters or adjusts one or more portions of the configuration. Some non-limiting examples of configuration permutations are a change in a sensor's sample rate or location, an addition or removal of noise to the sensor's data, an addition or removal of a sensor from a configuration, and the like.

An embodiment receives data from one or more sensors in the sensor configuration. Data from a physical sensor is referred to as real sensor data. An embodiment also generates virtual sensor data of one or more configuration permutations. Virtual sensor data is simulated data, i.e., data that a permutation is being simulated as generating. One embodiment uses real sensor data samples as a basis for generating virtual sensor data. Consider a time series of real sensor data with a particular sample rate. One embodiment virtually increases the time series' sample rate by inserting, between two adjacent real data points in the time series, an additional, virtual data point, obtained by averaging, interpolating, or otherwise combining the adjacent real data points. Another embodiment virtually decreases the time series' sample rate by removing, one or more data points from the time series. Another embodiment virtually inserts a sensor and its data into a new simulated location, by averaging, interpolating, or otherwise combining data from other locations into simulated data of the new location. Another embodiment generates virtual data by supplementing real sensor data with current real data from another location or historical real data. Another embodiment generates virtual data by supplementing real sensor data with current real data from another location or historical real data. Another embodiment generates virtual data by changing a data format of a stream of sensor data into a different format. Other embodiments generate virtual data by inserting additional noise into a stream of real sensor data, filtering a stream of real data to remove noise, or adjusting an amplitude or offset of a stream of real data. Another embodiment generates virtual data by adjusting one or more timestamps on real data, to compress or expand a time scale of a stream of data or to alter a time correlation of one set of data with another set of data. Other presently available techniques of using real sensor data samples as a basis for generating virtual sensor data are also possible and contemplated within the scope of the illustrative embodiments. Another embodiment generates virtual data without using real sensor data samples as a basis, instead using a presently available data generation technique to generate desired data.

An embodiment receives a contextual situation. A contextual situation specifies an analysis performed by another application on data from a sensor configuration, along with a quality measure of a result of the analysis. The quality measure specifies how the best analysis result is to be determined—e.g., a lowest error rate or a highest prediction accuracy rate. Optionally, a contextual situation also specifies a portion of a sensor configuration with which to perform the analysis. For example, one contextual situation might specify that the analysis is use of one or more carbon monoxide sensors to detect an above-threshold level of carbon monoxide. Another example contextual situation might specify that the analysis is detecting a thunderstorm.

An embodiment performs the analysis specified in the contextual situation, using a set of virtual sensor data generated using a permutation of the measured sensor configuration. The embodiment performs the same analysis using a set of real sensor data obtained using the measured sensor configuration. Another embodiment causes another system to perform the analysis specified in the contextual situation.

An embodiment uses the quality measure specified to determine the sensor configuration, measured or a permutation, which produced the best analysis outcome according to the specified quality measure. For example, if the analysis outcome for the measured configuration was an eighty percent prediction accuracy, the analysis outcome for permutation 1 of the measured configuration was an eighty-five percent accuracy, and the analysis outcome for permutation 2 of the measured configuration was a ninety-five percent accuracy, the best analysis outcome is the one obtained using permutation 2.

An embodiment stores, as a sensor configuration rule, the contextual situation and the sensor configuration producing the best analysis outcome for that contextual situation. One embodiment repeats the sensor configuration rule generation process, storing one or more additional sensor configuration rules appropriate to different contextual situations.

An embodiment receives a second contextual situation. An embodiment receives second sensor configuration data, and measures a second configuration of the set of sensors by analyzing the second sensor configuration data. An embodiment determines whether there is an existing sensor configuration rule specifying the second contextual situation. If so, an embodiment compares the second sensor configuration to the configuration specified in the existing rule, and if the two sensor configurations are different, adjusts a configuration of the sensors to the configuration specified in the existing sensor configuration rule. This configuration is referred to as a third configuration. For example, if the second sensor configuration indicates that a wind sensor is using a sample rate of once every thirty minutes, and the applicable sensor configuration rule specifies a sample rate for the wind sensor of once every minute, an embodiment adjusts the wind sensor's sample rate to once every minute.

An embodiment performs, or causes another system to perform, the analysis specified in the second contextual situation, using real sensor data generated using the third sensor configuration, generating a third analysis result. If the third analysis result has a quality measure (using the quality measure specified in the contextual situation) that is less than a threshold quality, the current sensor configuration needs improvement. Thus, an embodiment adjusts the third sensor configuration, resulting in a fourth sensor configuration.

An embodiment repeats the analysis and configuration adjustment until the current sensor configuration has a quality measure equal to or greater than a threshold quality, or until an iteration limit (a predefined constant) is reached. If the embodiment reaches a sensor configuration with a quality measure equal to or greater than a threshold quality, an embodiment updates the applicable sensor configuration rule with the current sensor configuration. However, reaching the iteration limit without achieving the desired quality measure indicates that the embodiment cannot achieve the desired quality measure using real sensor data obtained by further adjusting the sensor configuration.

Thus, an embodiment further adjusts the current sensor configuration, resulting in a fifth sensor configuration, and generates simulated sensor data according to the fifth sensor configuration. An embodiment performs, or causes another system to perform, the analysis specified in the second contextual situation, using simulated sensor data generated using the fifth sensor configuration, generating a fifth analysis result. If the fifth analysis result has a quality measure (using the quality measure specified in the contextual situation) that is less than a threshold quality, the current sensor configuration still needs improvement. Thus, an embodiment adjusts the fifth sensor configuration, generates simulated sensor data using the adjusted configuration, and repeats the analysis and further configuration adjustment until the current sensor configuration has a quality measure equal to or greater than a threshold quality, or until a second iteration limit (a predefined constant) is reached. Reaching the second iteration limit without achieving the desired quality measure indicates that the embodiment cannot achieve the desired quality measure, even using virtual sensor data.

An embodiment reports a sensor configuration used to achieve a particular quality measure, as well as being unable to achieve the desired quality measure using real sensor data, and using virtual sensor data. Reporting a sensor configuration and its capability or insufficiency gives a decision maker data with which to recommend replacing a virtual sensor data with a real sensor measuring real data, upgrading a real sensor with capabilities equivalent to a virtual sensor (e.g., an increased sample rate), and other real sensor configuration adjustments. Reporting a sensor configuration and its capability or insufficiency also gives a decision maker data with which to recommend not adjusting a real sensor configuration, as generated virtual data is producing a desired outcome without the need for purchasing and configuring a real sensor.

The manner of sensor configuration and data supplementation described herein is unavailable in the presently available methods in the technological field of endeavor pertaining to sensor management. A method of an embodiment described herein, when implemented to execute on a device or data processing system, comprises substantial advancement of the functionality of that device or data processing system in determining a sensor configuration rule from first configuration data of a set of sensors and a contextual situation, measuring, by analyzing second configuration data of the set of sensors, a second configuration of the set of sensors, and adjusting, according to the configuration specified in the sensor configuration rule, the second configuration, the adjustment resulting in a third configuration of the set of sensors

The illustrative embodiments are described with respect to certain types of sensors, configurations, permutations, real sensor data, virtual sensor data, analyses, quality measures, thresholds, rankings, adjustments, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

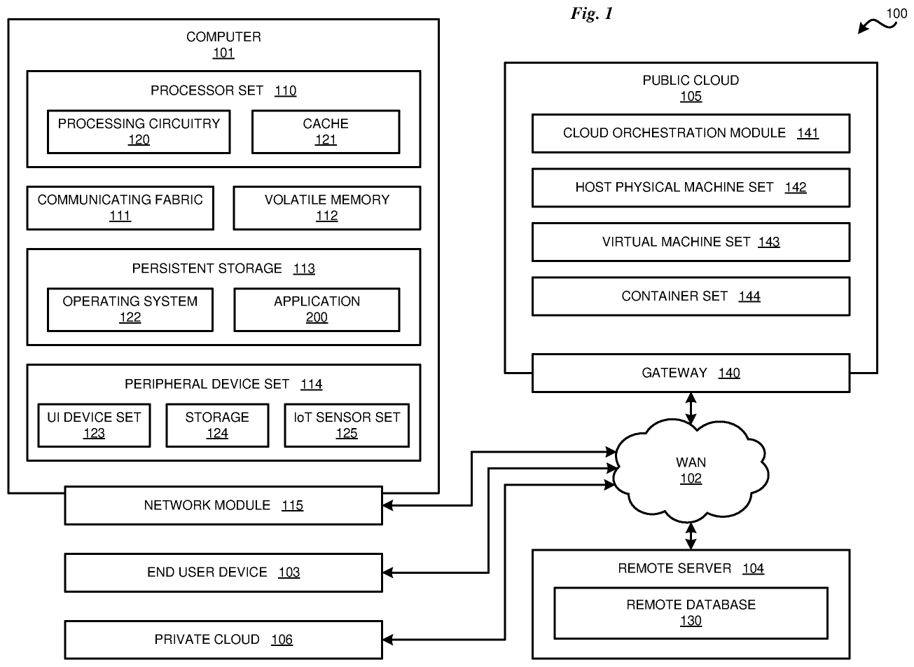

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a sensor configuration and data supplementation embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated. Application 200 communicates with, configures, and receives data from one or more sensors such as IoT sensor set 125.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

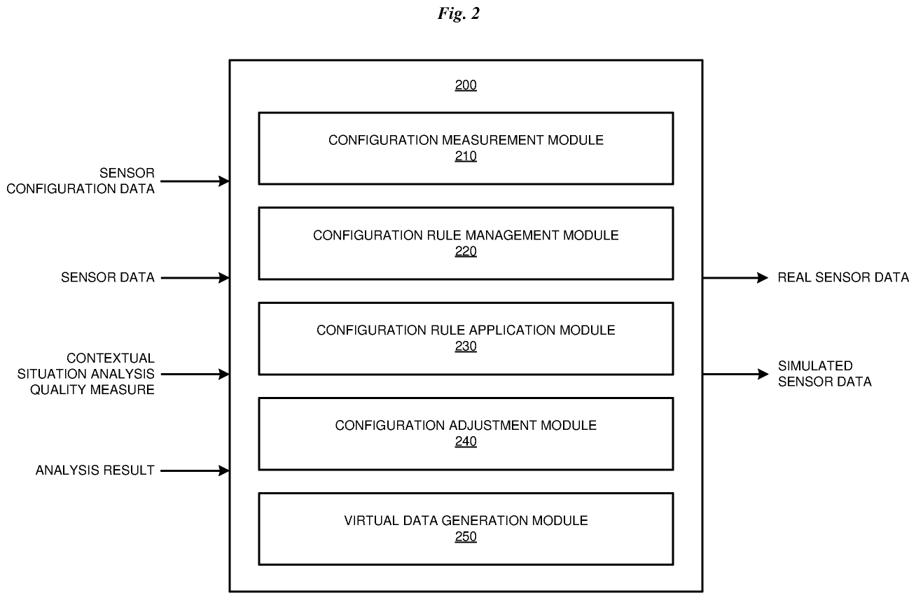

With reference to FIG. 2, this figure depicts a block diagram of an example configuration for sensor configuration and data supplementation in accordance with an illustrative embodiment. Application 200 is the same as application 200 in FIG. 1.

Application 200 receives configuration data of a set of sensors. The set of sensors includes at least one sensor. Some non-limiting examples of sensor configuration data are the type of data the sensor measures, the data format, sample rate, sensor location, relative position from another sensor, and the like. Configuration measurement module 210 measures a configuration of the set of sensors by analyzing the sensor configuration data. For example, one measured sensor configuration might be that the set of sensors includes two wind sensors, reporting data in a particular data format and using a sample rate of one sample per minute, located at geographic locations that are opposite ends of an airport runway. Another example measured sensor configuration might be that the set of sensors includes a thermometer, reporting data in a particular data format and using a sample rate of one sample every five minutes, located on the only floor of a house at a particular address. A third example measured sensor configuration might be that the set of sensors includes five combination smoke, carbon monoxide, and radon sensors, each reporting data in a particular data format and using a sample rate of one sample per minute, located in each bedroom, the kitchen, and the basement of a house at a particular address, as well as one thermometer located in a hallway and window-open sensors on every ground-floor window of the house.

Configuration rule management module 220 generates a set of permutations of the configuration of the set of sensors. To generate a configuration permutation, module 220 alters or adjusts one or more portions of the configuration. Some non-limiting examples of configuration permutations are a change in a sensor's sample rate or location, an addition or removal of noise to the sensor's data, an addition or removal of a sensor from a configuration, and the like.

Application 200 receives data from one or more sensors in the sensor configuration. Virtual data generation module 250 generates virtual sensor data of one or more configuration permutations. One implementation of module 250 uses real sensor data samples as a basis for generating virtual sensor data. Consider a time series of real sensor data with a particular sample rate. One implementation of module 250 virtually increases the time series' sample rate by inserting, between two adjacent real data points in the time series, an additional, virtual data point, obtained by averaging, interpolating, or otherwise combining the adjacent real data points. Another implementation of module 250 virtually decreases the time series' sample rate by removing, one or more data points from the time series. Another implementation of module 250 virtually inserts a sensor and its data into a new simulated location, by averaging, interpolating, or otherwise combining data from other locations into simulated data of the new location. Another implementation of module 250 generates virtual data by supplementing real sensor data with current real data from another location or historical real data. Another implementation of module 250 generates virtual data by supplementing real sensor data with current real data from another location or historical real data. Another implementation of module 250 generates virtual data by changing a data format of a stream of sensor data into a different format. Other implementations of module 250 generate virtual data by inserting additional noise into a stream of real sensor data, filtering a stream of real data to remove noise, or adjusting an amplitude or offset of a stream of real data. Another implementation of module 250 generates virtual data by adjusting one or more timestamps on real data, to compress or expand a time scale of a stream of data or to alter a time correlation of one set of data with another set of data. Another implementation of module 250 generates virtual data without using real sensor data samples as a basis, instead using a presently available data generation technique to generate desired data.

Application 200 receives a contextual situation. A contextual situation specifies an analysis performed by another application on data from a sensor configuration, along with a quality measure of a result of the analysis. Configuration rule management module 220 performs the analysis specified in the contextual situation, using a set of virtual sensor data generated using a permutation of the measured sensor configuration. Module 220 performs the same analysis using a set of real sensor data obtained using the measured sensor configuration. Another implementation of module 220 causes another system to perform the analysis specified in the contextual situation.

Module 220 uses the quality measure specified to determine the sensor configuration, measured or a permutation, that produced the best analysis outcome according to the specified quality measure, and stores, as a sensor configuration rule, the contextual situation and the sensor configuration producing the best analysis outcome for that contextual situation. One implementation of module 220 repeats the sensor configuration rule generation process, storing one or more additional sensor configuration rules appropriate to different contextual situations.

Application 200 receives a second contextual situation. Module 210 receives second sensor configuration data, and measures a second configuration of the set of sensors by analyzing the second sensor configuration data. Configuration rule application module 230 determines whether there is an existing sensor configuration rule specifying the second contextual situation. If so, module 230 compares the second sensor configuration to the configuration specified in the existing rule, and if the two sensor configurations are different, configuration adjustment module 240 adjusts a configuration of the sensors to the configuration specified in the existing sensor configuration rule. This configuration is referred to as a third configuration. For example, if the second sensor configuration indicates that a wind sensor is using a sample rate of once every thirty minutes, and the applicable sensor configuration rule specifies a sample rate for the wind sensor of once every minute, module 240 adjusts the wind sensor's sample rate to once every minute.

Application 200 performs, or causes another system to perform, the analysis specified in the second contextual situation, using real sensor data generated using the third sensor configuration, generating a third analysis result. If the third analysis result has a quality measure (using the quality measure specified in the contextual situation) that is less than a threshold quality, the current sensor configuration needs improvement. Thus, module 240 adjusts the third sensor configuration, resulting in a fourth sensor configuration.

Application 200 repeats the analysis and configuration adjustment until the current sensor configuration has a quality measure equal to or greater than a threshold quality, or until an iteration limit (a predefined constant) is reached. If module 240 reaches a sensor configuration with a quality measure equal to or greater than a threshold quality, module 220 updates the applicable sensor configuration rule with the current sensor configuration. However, reaching the iteration limit without achieving the desired quality measure indicates that the desired quality measure cannot be achieved using real sensor data obtained by further adjusting the sensor configuration.

Thus, application 200 further adjusts the current sensor configuration, resulting in a fifth sensor configuration, and virtual data generation module 250 generates simulated sensor data according to the fifth sensor configuration. Application 200 performs, or causes another system to perform, the analysis specified in the second contextual situation, using simulated sensor data generated using the fifth sensor configuration, generating a fifth analysis result. If the fifth analysis result has a quality measure (using the quality measure specified in the contextual situation) that is less than a threshold quality, the current sensor configuration still needs improvement. Thus, application 200 adjusts the fifth sensor configuration, generates simulated sensor data using the adjusted configuration, and repeats the analysis and further configuration adjustment until the current sensor configuration has a quality measure equal to or greater than a threshold quality, or until a second iteration limit (a predefined constant) is reached. Reaching the second iteration limit without achieving the desired quality measure indicates that application 200 cannot achieve the desired quality measure, even using virtual sensor data. Application 200 reports a sensor configuration used to achieve a particular quality measure, as well as being unable to achieve the desired quality measure using real sensor data, and using virtual sensor data.

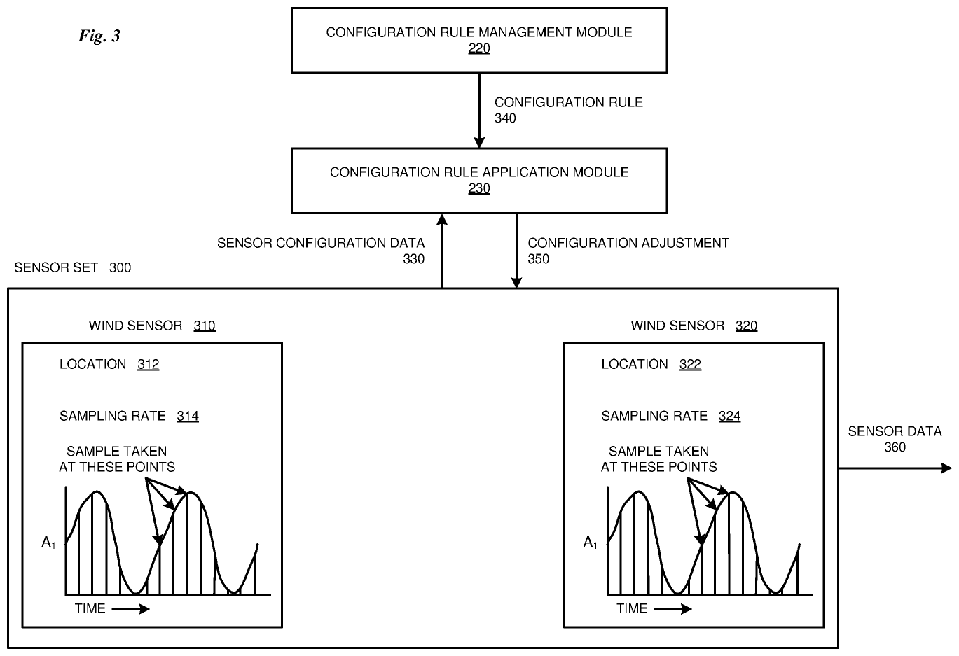

With reference to FIG. 3, this figure depicts an example of sensor configuration and data supplementation in accordance with an illustrative embodiment. The example can be executed using application 200 in FIG. 2. Configuration rule management module 220 and configuration rule application module 230 are the same as configuration rule management module 220 and configuration rule application module 230 in FIG. 2.

As depicted, sensor set 300 includes wind sensor 310, at location 312 and collecting data using sampling rate 314. Sensor set 300 also includes wind sensor 320, at location 322 and collecting data using sampling rate 324. Sampling rates 314 and 324 are different from each other, although this is not depicted in FIG. 3. Application 200 measures sensor configuration data 330 by analyzing configuration data of sensor set 300. Configuration rule application module 230 determines whether there is an existing sensor configuration rule specifying the current contextual situation. Here there is—configuration rule 340, managed by configuration rule management module 220. Thus, module 230 compares sensor configuration data 330 to the configuration specified in rule 340. If the two sensor configurations are different, configuration rule application module 230 produces configuration adjustment 350, adjusting sampling rate 324 to match sampling rate 314. As a result of adjustment 350, sensor set 300 produces sensor data 360.

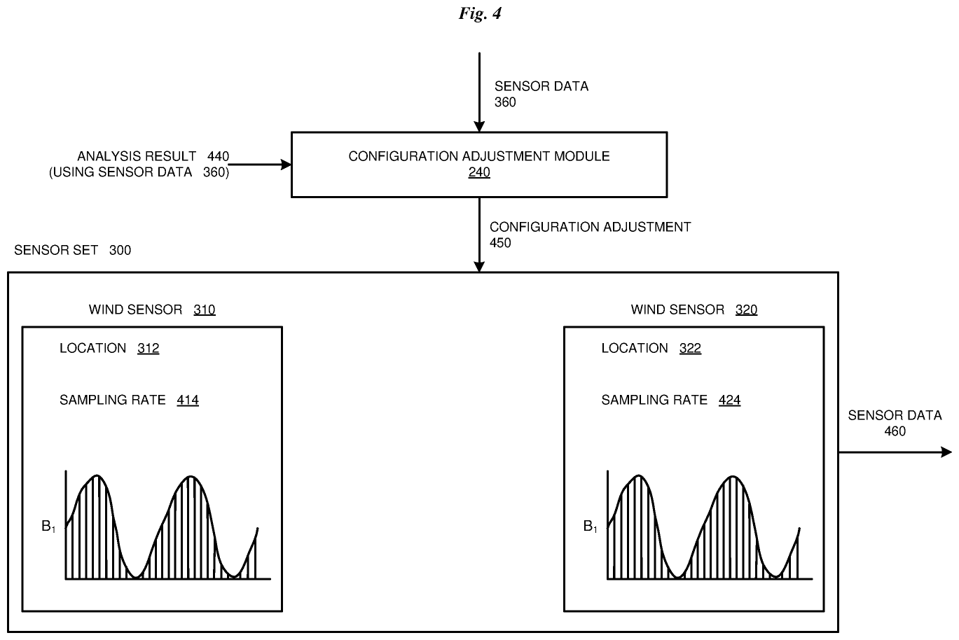

With reference to FIG. 4, this figure depicts a continued example of sensor configuration and data supplementation in accordance with an illustrative embodiment. Configuration adjustment module 240 is the same as configuration adjustment module 240 in FIG. 2. Sensor set 300, wind sensors 310 and 320, locations 312 and 324, and sensor data 360 are the same as sensor set 300, wind sensors 310 and 320, locations 312 and 324, and sensor data 360 in FIG. 3.

Here, application 200 has caused another system to perform the analysis specified in the current contextual situation, using sensor data 360 to generate analysis result 440. Analysis result 440 has a quality measure (using the quality measure specified in the contextual situation) that is less than a threshold quality, and thus the current sensor configuration needs improvement. As a result, module 240 performs configuration adjustment 450, adjusting wind sensor 310's sampling rate to sampling rate 414 and adjusting wind sensor 320's sampling rate to sampling rate 424. As a result of adjustment 450, sensor set 300 produces sensor data 460.

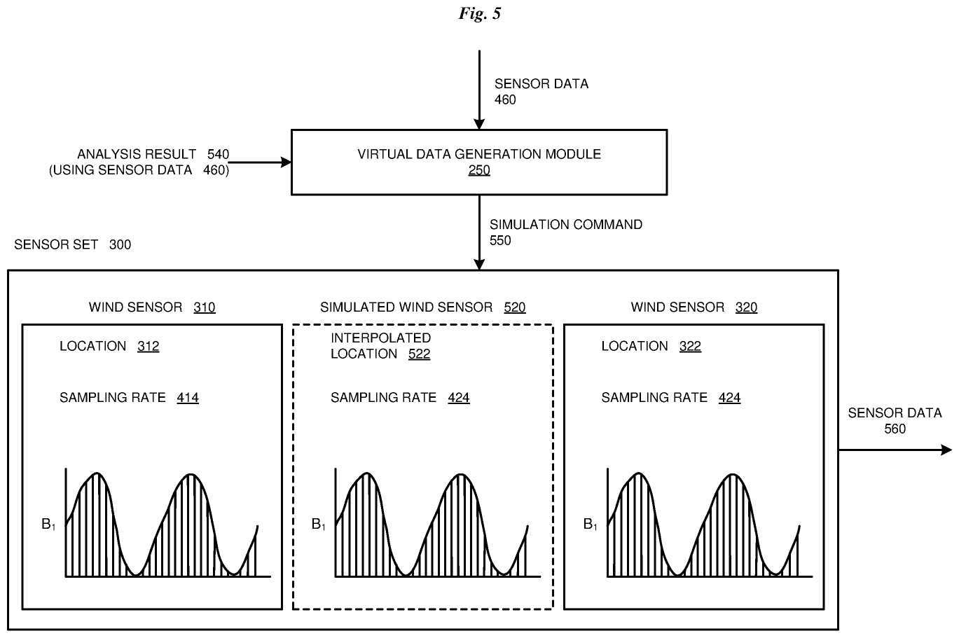

With reference to FIG. 5, this figure depicts a continued example of sensor configuration and data supplementation in accordance with an illustrative embodiment. Virtual data generation module 250 is the same as virtual data generation module 250 in FIG. 2. Sensor set 300, wind sensors 310 and 320, and locations 312 and 324 are the same as sensor set 300, wind sensors 310 and 320, and locations 312 and 324 in FIG. 3. Sampling rates 414 and 424 and sensor data 460 are the same as sampling rates 414 and 424 and sensor data 460 in FIG. 4.

Here, application 200 has caused another system to perform the analysis specified in the current contextual situation, using sensor data 460 to generate analysis result 540. Analysis result 540 has a quality measure (using the quality measure specified in the contextual situation) that is less than a threshold quality, and thus the current sensor configuration needs improvement. As a result, module 250 performs simulation command 550, resulting in simulated wind sensor 520 with interpolated location 522 (determined by interpolating between locations 312 and 322) and generating simulated data using sampling rate 424. As a result of command 450, sensor set 300 produces sensor data 560.

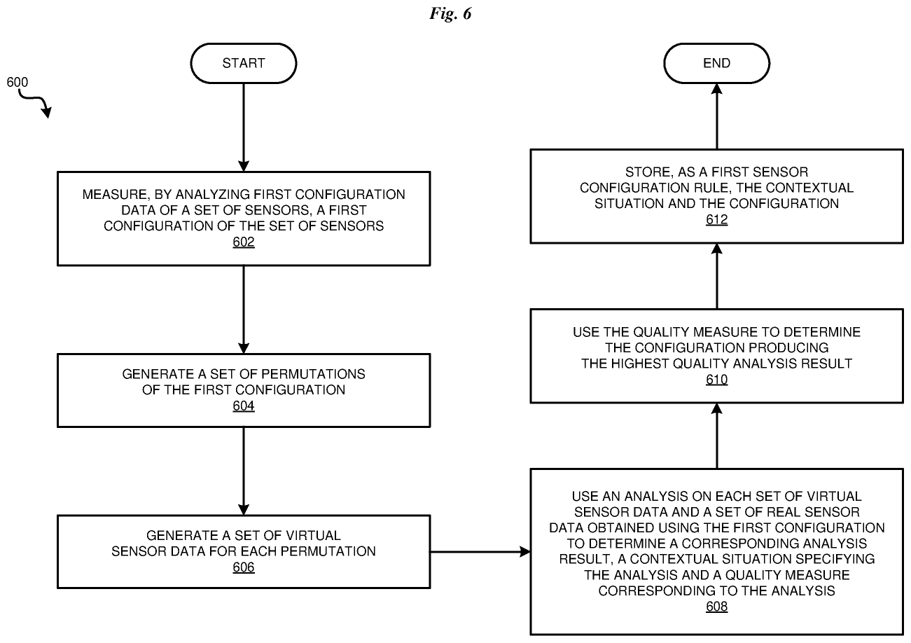

With reference to FIG. 6, this figure depicts a flowchart of an example process for sensor configuration and data supplementation in accordance with an illustrative embodiment. Process 600 can be implemented in application 200 in FIG. 2.

In block 602, the application measures, by analyzing first configuration data of a set of sensors, a first configuration of the set of sensors. In block 604, the application generates a set of permutations of the first configuration. In block 606, the application generates a set of virtual sensor data for each permutation. In block 608, the application uses an analysis on each set of virtual sensor data and a set of real sensor data obtained using the first configuration to determine a corresponding analysis result, a contextual situation specifying the analysis and a quality measure corresponding to the analysis. In block 610, the application uses the quality measure to determine the configuration producing the highest quality analysis result. In block 612, the application stores, as a first sensor configuration rule, the contextual situation and the configuration. Then the application ends.

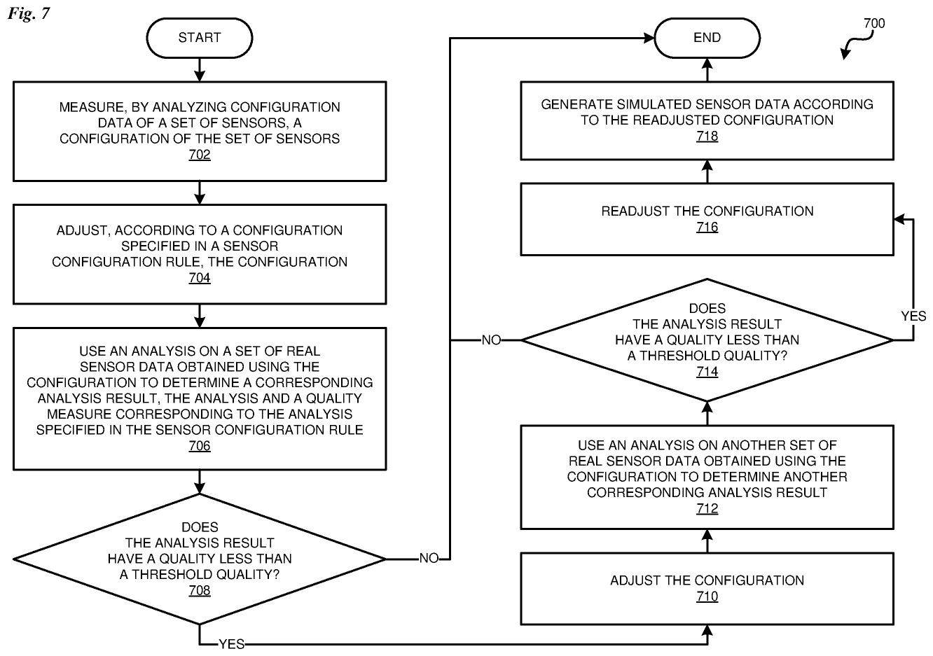

With reference to FIG. 7, this figure depicts a flowchart of an example process for sensor configuration and data supplementation in accordance with an illustrative embodiment. Process 700 can be implemented in application 200 in FIG. 2.

In block 702, the application measures, by analyzing configuration data of a set of sensors, a configuration of the set of sensors. In block 704, the application adjusts, according to a configuration specified in a sensor configuration rule, the configuration. In block 706, the application uses an analysis on a set of real sensor data obtained using the configuration to determine a corresponding analysis result, the analysis and a quality measure corresponding to the analysis specified in the sensor configuration rule. In block 708, the application determines whether the analysis yes result have a quality less than a threshold quality. If so (“YES” path of block 708), in block 710, the application adjusts the configuration. In block 712, the application uses an analysis on another set of real sensor data obtained using the configuration to determine another corresponding analysis result. In block 714, the application determines whether the analysis result have a quality less than a threshold quality. If so (“YES” path of block 714), in block 716, the application readjusts the configuration. In block 718, the application generates simulated sensor data according to the readjusted configuration. Then (also “NO” paths of block 708 and 714) the application ends.

Thus, a computer implemented method, system or apparatus, and computer program product are provided in the illustrative embodiments for sensor configuration and data supplementation and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
measuring, by analyzing first configuration data of a set of sensors, a first configuration of the set of sensors;
generating a set of permutations of the first configuration, a permutation in the set of permutations comprising an adjusted configuration of the set of sensors;
generating, for each permutation in the set of permutations, a corresponding set of virtual sensor data;
causing determining, using an analysis on each set of virtual sensor data and a set of real sensor data obtained using the first configuration, a corresponding analysis result, a contextual situation specifying the analysis and a quality measure corresponding to the analysis;
determining, using the quality measure, a configuration producing a highest quality analysis result;
store, as a sensor configuration rule, the contextual situation and the configuration;
measuring, by analyzing second configuration data of the set of sensors, a second configuration of the set of sensors; and
adjusting, according to the configuration specified in the sensor configuration rule, the second configuration, the adjusting resulting in a third configuration of the set of sensors.

2. The computer-implemented method of claim 1, wherein the adjusted configuration comprises an adjustment of a sample rate of a sensor in the set of sensors.

3. The computer-implemented method of claim 1, wherein the adjusted configuration comprises an adjustment of a location of a sensor in the set of sensors.

4. The computer-implemented method of claim 1, wherein the corresponding set of virtual sensor data is generated by inserting, into a time series of real sensor data of a sensor in the set of sensors, virtual sensor data.

5. The computer-implemented method of claim 1, wherein the corresponding set of virtual sensor data is generated by inserting, into the first configuration, a simulated sensor at a simulated location, the simulated sensor generating virtual sensor data of the simulated location.

6. The computer-implemented method of claim 5, wherein the virtual sensor data of the simulated location is generated by interpolating real sensor data of a plurality of sensors in the set of sensors.

7. The computer-implemented method of claim 1, further comprising:
causing determining, using an analysis on a third set of sensor data obtained using the third configuration, a third analysis result, the analysis and a quality measure corresponding to the analysis specified in the sensor configuration rule; and
adjusting, responsive to determining that the third analysis result has a third quality less than a threshold quality, the third configuration, the third quality determined using the quality measure, the adjusting resulting in a fourth configuration of the set of sensors.

8. The computer-implemented method of claim 7, further comprising:
causing determining, using the analysis on a fourth set of sensor data obtained using the fourth configuration, a fourth analysis result; and
generating, responsive to determining that the fourth analysis result has a fourth quality less than a threshold quality, simulated sensor data according to a fifth configuration of the set of sensors, the fifth configuration comprising an adjustment of the fourth configuration of the set of sensors, the fourth quality determined using the quality measure.

9. A computer program product comprising one or more computer readable storage medium, and program instructions collectively stored on the one or more computer readable storage medium, the program instructions executable by a processor to cause the processor to perform operations comprising:
measuring, by analyzing first configuration data of a set of sensors, a first configuration of the set of sensors;
generating a set of permutations of the first configuration, a permutation in the set of permutations comprising an adjusted configuration of the set of sensors;
generating, for each permutation in the set of permutations, a corresponding set of virtual sensor data;
causing determining, using an analysis on each set of virtual sensor data and a set of real sensor data obtained using the first configuration, a corresponding analysis result, a contextual situation specifying the analysis and a quality measure corresponding to the analysis;
determining, using the quality measure, a configuration producing a highest quality analysis result;
store, as a sensor configuration rule, the contextual situation and the configuration;
measuring, by analyzing second configuration data of the set of sensors, a second configuration of the set of sensors; and
adjusting, according to the configuration specified in the sensor configuration rule, the second configuration, the adjusting resulting in a third configuration of the set of sensors.

10. The computer program product of claim 9, wherein the stored program instructions are stored in a computer readable storage device in a data processing system, and wherein the stored program instructions are transferred over a network from a remote data processing system.

11. The computer program product of claim 9, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

12. The computer program product of claim 9, wherein the adjusted configuration comprises an adjustment of a sample rate of a sensor in the set of sensors.

13. The computer program product of claim 9, wherein the adjusted configuration comprises an adjustment of a location of a sensor in the set of sensors.

14. The computer program product of claim 9, wherein the corresponding set of virtual sensor data is generated by inserting, into a time series of real sensor data of a sensor in the set of sensors, virtual sensor data.

15. The computer program product of claim 9, wherein the corresponding set of virtual sensor data is generated by inserting, into the first configuration, a simulated sensor at a simulated location, the simulated sensor generating virtual sensor data of the simulated location.

16. The computer program product of claim 15, wherein the virtual sensor data of the simulated location is generated by interpolating real sensor data of a plurality of sensors in the set of sensors.

17. The computer program product of claim 9, further comprising:
causing determining, using an analysis on a third set of sensor data obtained using the third configuration, a third analysis result, the analysis and a quality measure corresponding to the analysis specified in the sensor configuration rule; and
adjusting, responsive to determining that the third analysis result has a third quality less than a threshold quality, the third configuration, the third quality determined using the quality measure, the adjusting resulting in a fourth configuration of the set of sensors.

18. The computer program product of claim 17, further comprising:
causing determining, using the analysis on a fourth set of sensor data obtained using the fourth configuration, a fourth analysis result; and
generating, responsive to determining that the fourth analysis result has a fourth quality less than a threshold quality, simulated sensor data according to a fifth configuration of the set of sensors, the fifth configuration comprising an adjustment of the fourth configuration of the set of sensors, the fourth quality determined using the quality measure.

19. A computer system comprising a processor and one or more computer readable storage media, and program instructions collectively stored on the one or more computer readable storage media, the program instructions executable by the processor to cause the processor to perform operations comprising:
measuring, by analyzing first configuration data of a set of sensors, a first configuration of the set of sensors;
generating a set of permutations of the first configuration, a permutation in the set of permutations comprising an adjusted configuration of the set of sensors;
generating, for each permutation in the set of permutations, a corresponding set of virtual sensor data;
causing determining, using an analysis on each set of virtual sensor data and a set of real sensor data obtained using the first configuration, a corresponding analysis result, a contextual situation specifying the analysis and a quality measure corresponding to the analysis;
determining, using the quality measure, a configuration producing a highest quality analysis result;
store, as a sensor configuration rule, the contextual situation and the configuration;
measuring, by analyzing second configuration data of the set of sensors, a second configuration of the set of sensors; and
adjusting, according to the configuration specified in the sensor configuration rule, the second configuration, the adjustment resulting in a third configuration of the set of sensors.

20. The computer system of claim 19, wherein the adjusted configuration comprises an adjustment of a sample rate of a sensor in the set of sensors.
